(19) United States
(12) Patent Application Publication
(10) Pub. No.: US 2005/0259819 A1
(43) Pub. Date: Nov. 24, 2005

(54) Method for generating hashes from a compressed multimedia content

(75) Inventors: Arnoldus Werner Johannes Oomen, Eindhoven (NL); Antonius Adrianus Cornelis Maria Kalker, Eindhoven (NL); Jakobus Middeljans, Eindhoven (NL); Jaap Andre Haitsma, Eindhoven (NL)

Correspondence Address: PHILIPS INTELLECTUAL PROPERTY & STANDARDS, P.O. BOX 3001, BRIARCLIFF MANOR, NY, 10510, US

(73) Assignee: Koninklijke Philips Electronics

(21) Appl. No.: 10/518,264

(22) PCT Filed: Apr. 12, 2003
(86) PCT No.: PCT/IB03/02625

§ 371 Date: Dec. 16, 2004

(30) Foreign Application Priority Data
Jun. 24, 2002 (EP) 02077499.8

(51) Int. Cl. H04N 7/167

(52) U.S. Cl. 380/200

(57) ABSTRACT

Method and apparatus for generating a hash signal representative of a multimedia signal are described. The method includes receiving a bit-stream comprising a compressed multimedia signal, selectively reading from the bit-stream predetermined parameters, and deriving a hash function from the parameters.

### FIELD OF THE INVENTION

The invention relates to a method and apparatus suitable for the generation of a hash signal representative of a multimedia signal.

### BACKGROUND OF THE INVENTION

Hash functions are commonly used in the world of cryptography where they are commonly used to summarise and verify large amounts of data. For instance, the MD5 algorithm, developed by Professor R L Rivest of MIT (Massachusetts Institute of Technology), has as an input a message of arbitrary length and produces as an output a 128-bit “finger print”, “signature” or “hash” of the input. It has been conjectured that it is statistically very unlikely that two different messages have the same hash. Consequently, such cryptographic hash algorithms are a useful way to verify data integrity.

In many applications, identification of multimedia signals, including audio and/or video content, is desirable. However, multimedia signals can frequently be transmitted in a variety of file formats. For instance, several different file formats exist for audio files, like WAV, MP3 and Windows Media, as well as a variety of compression or quality levels. Cryptographic hashes such as MD5 are based on the binary data format, and so will provide different hash values for different file formats of the same multimedia content. This makes cryptographic hashes unsuitable for summarising multimedia data, for which it is required that different quality versions of the same content yield the same hash, or at least similar hashes.

Hashes of multimedia content that are relatively invariant to data processing (as long as the processing retains an acceptable quality of the content), are referred to as robust summaries, robust signatures, robust fingerprints, perceptual hashes or robust hashes. Robust hashes capture the perceptually essential parts of audio-visual content, as perceived by the Human Auditory System (HAS) and/or the Human Visual System (HVS).

One definition of a robust hash is a function that associates with every basic time-unit of multimedia content a semi-unique bit-sequence that is continuous with respect to content similarity as perceived by the HAS/HVS. In other words, if the HAS/HVS identifies two pieces of audio, video or image as being very similar, the associated hashes should also be very similar. In particular, the hashes of original content and compressed content should be similar. On the other hand, if two signals really represent different content, the robust hash should be able to distinguish the two signals (semi-unique). Consequently, robust hashing enables content identification, which is the basis for many applications.

The article “robust Audio Hashing for Content Identification”, Content Based Multimedia Indexing 2001, Brescia, Italy, September 2001, by Jaap Haitsma, Ton Kalker and Job Oostveen, describes a robust audio hashing technique, and further a scheme incorporating the technique that allows unknown audio content to be identified by hashing the content and comparing it with a database of robust hash values.

The proposed technique computes a robust hash value for basic windowed time intervals of the audio signal. The audio signal is thus divided into frames, and subsequently the spectral representation of each time frame computed by a Fourier transform. The technique aims to provide a robust hash function that mimics the behaviour of the HAS i.e. it provides a hash value mimicking the content of the audio signal as would be perceived by a listener.

In such a hashing technique, as illustrated in FIG. 1, the bit-stream including the encoded audio signal is received by a bit-stream decoder 110. The bit-stream decoder fully decodes the bit-stream, so as to produce an audio signal. This audio signal is then passed to the framing unit 120. The framing unit divides the audio signal into a series of basic windowed time intervals. Preferably, the time intervals overlap, such that the resulting hash values from subsequent frames are largely similar.

Each of the windowed time intervals signals are then passed to a Fourier transform unit 130, which calculates a Fourier transform for each time window. An absolute value calculating unit 140 is then used to calculate the absolute value of the Fourier transform. This calculation is carried out as the Human Auditory System (HAS) is relatively insensitive to phase, and only the absolute value of the spectrum is retained as this corresponds to the tone that would be heard by the human ear.

In order to allow for the calculation of a separate hash value for each of a predetermined series of frequency bands within the frequency spectrum, selectors, 151, 152, . . . , 158, 159 are used to select the Fourier coefficients corresponding to the desired bands. The Fourier coefficients for each band are then passed to respective energy computing stages 161, 162, . . . , 168, 169. Each energy computing stage then calculates the energy of each of the frequency bands, and then passes the computed energy onto a bit derivation circuit 170 which computes and sends to the output 180 a hash bit (H(n,x), where x corresponds to the respective frequency band and n corresponds to the relevant time frame interval). In the simplest case, the bits can be a sign indicating whether the energy is greater than a predetermined threshold. By collating the bits corresponding to a single time frame, a hash word is computed for each time frame.

Similarly, the article “J. C. Oostveen, A. A. C. Kalker, J. A. Haitsma, “Visual Hashing of Digital Video: Applications and Techniques”, SPIE, Applications of Digital Image Processing XXUV, July 31-Aug. 3, 2001, San Diego, USA, describes a technique for extracting essential perceptual features from a moving image sequence, and identifying any sufficiently long unknown video segment by efficiently matching the hash value of a short segment with a large database of pre-computed hash values.

As the technique relates to visual hashing, the perceptual features relate to those that would be viewed by the HVS i.e. it aims to produce the same (or a similar) hash signal for content that is considered the same by the HVS. The proposed algorithm looks to consider features extracted from either the luminance component, or alternatively the chrominance components, computed over blocks of pixels.

In both of the above described audio and visual robust hashing schemes, the respective information (audio or visual) signal is decoded from the bit-stream, divided into frames, then the perceptual features extracted from the frames and utilised to calculate a hash signal.

### OBJECT AND SUMMARY OF THE INVENTION

It is a general object of the invention to provide a robust hashing technique.

It is also an object of the invention to provide a method and arrangement for determining a hash of a multimedia signal encoded within a bit-stream.

In a first aspect, the present invention provides a method of generating a hash signal representative of a multimedia signal, the method comprising the steps of: receiving a bit-stream comprising a compressed multimedia signal; selectively reading from the bit-stream predetermined parameters; and deriving a hash function from said parameters.

In a second aspect, the present invention provides a hash signal representative of a multimedia signal, the hash signal having been generated by selectively reading predetermined parameters relating to perceptual properties of the multimedia signal from a bit-stream comprising a compressed version of the multimedia signal.

In a further aspect, the present invention provides an apparatus arranged to generate a hash signal representative of a multimedia signal, the apparatus comprising: a receiver arranged to receive a bit-stream comprising a compressed multimedia signal; a decoder arranged to selectively read from the bit-stream predetermined parameters; a processing unit arranged to derive a hash function from said parameters.

Further features of the invention are defined in the dependent claims.

### BRIEF DESCRIPTION OF THE DRAWINGS

For a better understanding of the invention, and to show how embodiments of the same may be carried into effect, reference will now be made, by way of example, to the accompanying diagrammatic drawings in which:

FIG. 1 is a schematic diagram of a known arrangement for extracting a hash signal from an audio signal encoded within a bit-stream; and

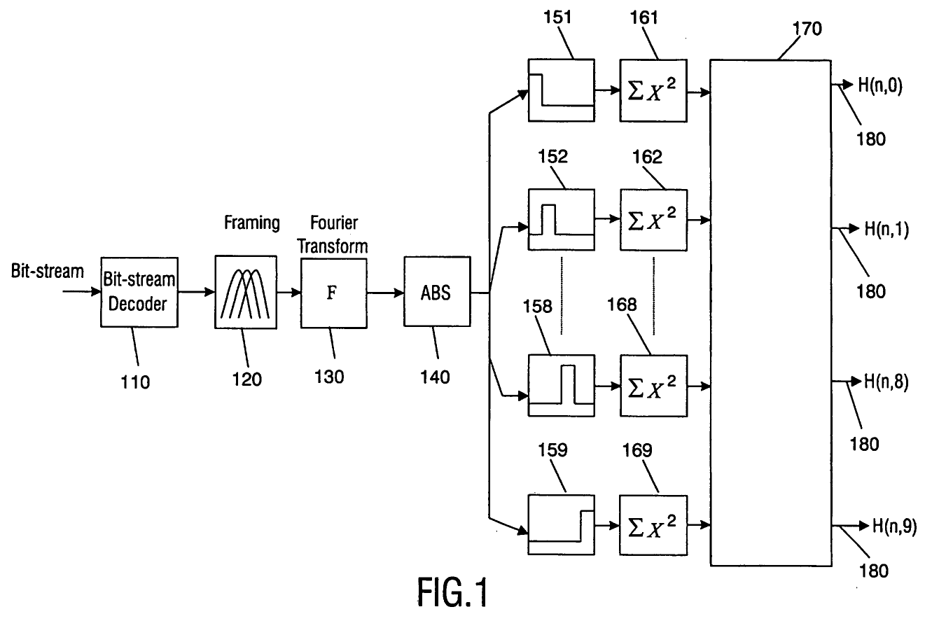

FIG. 2 is a schematic diagram of an arrangement for extracting a hash signal from an encoded multimedia signal in accordance with an embodiment of the present invention.

### DETAILED DESCRIPTION OF PREFERRED EMBODIMENTS

Prior art robust hashing schemes require that the respective information signal is decoded from the encoded signal (i.e. the bit-stream), with the decoded information signal being sampled so as to extract the relevant perceptual information. This perceptual information is subsequently utilised to determine the hash function.

The present inventors have realised that the complete decoding of the transmission signal is not necessary. The hash function can instead in many instances be directly determined from the bit-stream representation.

Multimedia signals are typically encoded using source coding so as to form efficient descriptions of information sources. Source coded data can then be efficiently transmitted in a bit-stream.

In order for the multimedia signal to be recognisable when decoded, the encoded signal must contain information relating to the perceptual features of the multimedia signal. For instance, transform, subband and parametric encoded audio signals all contain spectral representations of the audio signal.

It has been realised that such perceptual information can be extracted from the bit-stream containing the encoded multimedia signal, and directly used to calculate the hash function without decoding the whole bit-stream signal. This improves upon normal hash function calculations, which require both the relatively complex operation of the decoding of the encoded bit-stream, and also the subsequent derivation of a spectral representation (or other perceptual property) of the decoded multimedia signal.

Subsequently, for each band in a predetermined set of bands a certain (not necessarily scalar) characteristic property is calculated. In this description, it is assumed that a band holds one or more spectral values that are representative for a frequency region of the encoded signal. Examples of such properties are energy, tonality and standard deviation of the power spectral density. In general, the chosen property can be any predetermined function of the perceptual coefficients. Experimentally, it has been verified that the sign of energy differences (simultaneously along the time and frequency axis) is a property that is very robust to many kinds of processing.

The robust properties are subsequently converted into bits, each bit being indicative of the energy change within a frequency band of the respective frame, with all of the bits of a frame representing the hash for that frame.

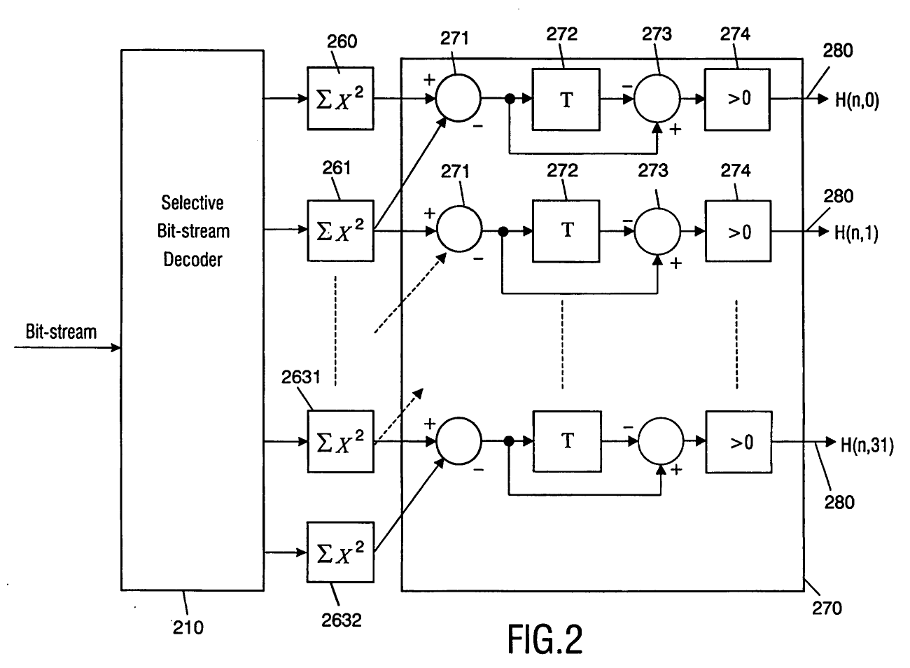

FIG. 2 illustrates an apparatus suitable for calculating a hash function directly from a bit-stream incorporating an encoded multimedia signal. The operation of the apparatus will now be described in conjunction with a transform encoded audio signal.

Transform coders are typically called spectral encoders because the signal is described in terms of a spectral decomposition (in a selected basis set). The spectral terms are computed for overlapping (typically having a 50% overlap) successive blocks of input data. Thus the output of a transform coder can be viewed as a set of time series, one series for each spectral term.

Thus, when undergoing transform coding, the input audio signal will be filtered resulting in a large number of spectral coefficients. Typically, these coefficients are grouped in frequency bands, denoted as scale-factor bands, that resemble a non-uniform frequency division such as an ERB-grid (Equivalent Rectangular Bandwidth grid). For each scale-factor band, one scale-factor is encoded in the bit-stream that scales the spectral coefficients. The resulting spectral coefficients are quantized according to a perceptual model, and subsequently encoded into a bit-stream representation.

FIG. 2 shows a schematic diagram of an apparatus 200 arranged to receive such a bit-stream. The bit-stream is received at the input of the selective bit-stream decoder 210. The decoder 210 is arranged to selectively extract bits from the bit-stream relating to predetermined parameters of the multimedia signal. These predetermined parameters are then utilised to determine the hash function. In the preferred embodiment for a transform encoded audio signal, the scale-factors (and optionally the spectral values) per scale factor band are extracted from the bit-stream. These scale-factors and spectral values are subsequently processed in order to obtain energies. In principle the scale-factors alone give an estimate of the energies. The estimates are made more precise if the spectral values are also taken into account. In the simplest case, these values are then utilised to calculate the hash function.

However, in the preferred embodiment, these values are then passed to calculation units 260, 261, . . . , 2631, 2632. Each calculation unit corresponds to a separate ERB frequency band, and is used to derive an estimate of the energies per ERB frequency band from the decoded scale-factors (and optionally from the spectral values) per scale factor band. In the preferred embodiment, the ERB bands have a logarithmic spacing, with the first band starting at 300 Hz, and every successive band having a bandwidth of one musical tone up to the maximum frequency of 3000 Hz (the most relevant frequency range to the HAS).

In order to derive the binary hash word for each frame of the multimedia signal, the energies are subsequently converted into bits. The bits can be assigned by calculating an arbitrary function of the energies of possibly different frames, and then comparing it to a threshold value. The threshold itself might also be the result of another function of the energy values.

In this preferred embodiment, the bit derivation circuit 270 converts the energy levels of the bands into a binary hash word.

If the energy of band m of frame n is denoted by EB(n,m) and the m-th bit of the hash H of frame n by H(n,m), the bits of the hash string can be formally defined as:

$$H ( n , m ) = \{ \begin{matrix}1 & if & EB ( n , m ) - EB ( n , m + 1 ) - ( EB ( n - 1 , m ) - EB ( n - 1 , m + 1 ) ) > 0 \\ 0 & if & EB ( n , m ) - EB ( n , m + 1 ) - ( EB ( n - 1 , m ) - EB ( n - 1 , m + 1 ) ) \leq 0\end{matrix} \qquad ( 1 )$$

In order to calculate these values, the bit derivation circuit 270 comprises, for each band, a first subtractor 271, a frame delay 272, a second subtractor 273, and a comparator 274. In the preferred embodiment, which includes 33 energy levels, or 33 energy levels of the spectrum of an audio frame are thus converted into a 32-bit hash word i.e. H(n,m). A separate hash word is calculated for each time frame in the audio signal, with a concatenation of the hash words forming the overall hash function.

Such computed hash words of successive frames can be stored in buffers, or other memory stores, and utilised by computers to match the multimedia signal encoded in the bit-stream by comparing it with a database of hash values that have been calculated in a similar manner.

Whilst the above embodiment has been described with reference to a particular type of coding scheme, it will be appreciated that it can be applied to any coding scheme that stores perceptual information.

For every coding scheme that exists, there also exists a “syntax description” and “decoder description”. Such descriptions can be either standardised or proprietary. The syntax description contains the structure of the bit-stream, and how to write or extract (read) encoded parameters to and from the bit-stream. The decoder description describes how to decode these extracted parameters and subsequently generate the multimedia output. Thus, for any given particular coding scheme, using the syntax description it is possible to locate the desired specific parameters relating to the desired perceptual information. These parameters can thus be extracted without fully parsing or decoding the bit-stream.

For instance, in subband coders, the encoding process is similar to that utilised in transform coders. The audio input signal is filtered resulting in a limited number of sub-signals. Each sub-signal represents signal values in a frequency band of fixed size. The thus obtained sub-signals are then quantized according to a perceptual model, and subsequently encoded into a bit-stream representation. Along with the signal values also scale-factors, that scale the signal values, are encoded in the bit-stream.

Thus, in order to calculate a hash function from the subband encoded description, the scale-factors per subband are extracted from the bit-stream. Optionally, the signal values, i.e. the actual (scaled) spectral values are extracted from the bit-stream, if a more precise estimate of the energies is required. The extracted parameters are subsequently converted into energies. The energies within subbands that correspond to a “critical” band are then grouped. Critical bands are those predetermined frequency bands that have been determined to contain the desired perceptual information required to form robust hashes.

In the case that a critical band does not exactly match a subband border, an estimation of the energy within the critical band can be made e.g. by taking a fractional part of the subband energy, by, for instance, using linear interpolation (or any other desired order of interpolation).

As in the method described with respect to FIG. 2, this data can then be passed to a bit derivation circuit in order for the hash function to be calculated. Similar to transform coding, these scale factors could also be used to further reduce complexity.

Alternatively, a parametric encoding scheme has been developed by Philips in which the audio signal is represented by means of transients, noise and sinusoids. This scheme is described in the article by E.Schuijers, B.den Brinker and W. Oomen, “Parametric coding for High Quality Audio”, Preprint 5554, 112^{th} AES Convention Munich, 10-13 May 2002.

In this technique, using spectral analysis methods, sinusoidal components are estimated. These sinusoidal components, at predetermined time intervals, represent the frequencies that are present in the audio signal. In the preferred scheme, the sinusoidal parameters are updated about every eight milliseconds. For coding efficiency, the sinusoidal frequencies are quantized on an ERB-grid, which resembles a logarithmic grid. The representation levels, which are obtained after quantization, are subsequently differentially encoding, both in the frequency direction as well as in the time direction, and encoded into a bit-stream representation.

In order to calculate a hash function from a parametric representation, the frequencies that are contained in the parametric bit-stream are extracted, and grouped within the frequency regions used for the hash operation. For each time frame and frequency within a group (i.e. frequency band), the amplitude (and optionally the phase information) is retrieved in order to calculate the energy of all components within a frequency group. This data can then be used to calculate the hash function.

The phase information is optionally used as, for low frequencies, the phase information has an influence on the actual power contained in the sinusoid. Depending on the starting phase of the sinusoid, the power can fluctuate. For that reason it can be appropriate to include phase information, particularly if the multi-media signal includes many low frequency components.

In the parametric representation, since most of the energy of the audio signal is contained in the sinusoidal components, it is reasonable to calculate the hash function considering only the sinusoidal parameters. However, if desired, the influence of the energies contained in the transient and noise components can also be utilised.

Each transient object is only present within a single time frame. In the same way as the sinusoidal object, the frequencies that are contained within the transient object are grouped within frequency bands, with the corresponding amplitude and phase information contributing to the total energy within a frequency band. As the sinusoids within a transient object are weighted with an envelope function, this envelope function also needs to be considered when determining the energy per component.

Inclusion of the energies contained in the noise signal components is less straight forward, and would significantly increase the computational complexity. However, by concentrating on the main sinusoidal components of the noise signal, a sufficiently reliable feature signal may be obtained, thus allowing the construction of a hashing word from these sinusoidal components.

It will be appreciated by the skilled person that various implementations not specifically described would be understood as falling within the scope of the present invention. For instance, whilst only the functionality of the hash generation apparatus has been described, it will be appreciated that the apparatus could be realised as a digital circuit, an analog circuit, a computer program, or a combination thereof.

Equally, whilst the above embodiments have been described with reference to specific types of encoding schemes, it will be appreciated that the present invention can be applied to other types of coding schemes, particularly those that contain coefficients relating to perceptually significant information when carrying multimedia signals.

Many encoding schemes will divide multimedia signals simultaneously into predetermined time frames, and blocks of perceptual features for each time frame. For instance, a video signal may, for each image, be divided into square blocks of pixels. Equally, an audio signal may be divided into predetermined frequency bands. In the event that it is desirable to calculate a hash function from time frames and/or blocks of perceptual features that do not match those used in the encoding scheme, it will be appreciated that further processing may be carried out on the components relating to the perceptual features extracted from the bit stream, so as to estimate the properties of the multimedia signal falling within the desired time frames and/or perceptual blocks based upon the time frames or perceptual blocks used in the encoding scheme.

The reader's attention is directed to all papers and documents which are filed concurrently with or previous to this specification in connection with this application and which are open to public inspection with this specification, and the contents of all such papers and documents are incorporated herein by reference.

All of the features disclosed in this specification (including any accompanying claims, abstract and drawings), and/or all of the steps of any method or process so disclosed, may be combined in any combination, except combinations where at least some of such features and/or steps are mutually exclusive.

Each feature disclosed in this specification (including any accompanying claims, abstract and drawings), may be replaced by alternative features serving the same, equivalent or similar purpose, unless expressly stated otherwise. Thus, unless expressly stated otherwise, each feature disclosed is one example only of a generic series of equivalent or similar features.

The invention is not restricted to the details of the foregoing embodiment(s). The invention extends to any novel one, or any novel combination, of the features disclosed in this specification (including any accompanying claims, abstract and drawings), or to any novel one, or any novel combination, of the steps of any method or process so disclosed.

Within the specification it will be appreciated that the word “comprising” does not exclude other elements or steps, that “a” or “and” does not exclude a plurality, and that a single processor or other unit may fulfil the functions of several means recited in the claims.

1. A method of generating a hash signal representative of a multimedia signal, the method comprising the steps of:
receiving a bit-stream comprising a compressed multimedia signal;
selectively reading from the bit-stream predetermined parameters; and
deriving a hash function from said parameters.

2. A method as claimed in claim 1, wherein said predetermined parameters relate to perceptual information of the multimedia signal.

3. A method as claimed in claim 1, wherein the multimedia signal comprises at least one of an audio signal, a video signal and an image signal.

4. A method as claimed in claim 1, wherein the multimedia signal has been compressed using at least one of transform encoding, subband encoding and parametric encoding.

5. A method as claimed in claim 1, wherein said predetermined parameters relate to at least one of the energies of frequency bands; the amplitudes of frequency bands; the tonality of frequency bands; the luminance of an area of a video signal; and the chrominance of an area of a video signal.

6. A method as claimed in claim 1, wherein the method further comprises the step of analysing the received bit-stream in order to determine the decoding scheme used to compress the multimedia signal.

7. A method as claimed in claim 6, wherein said analysing step comprises comparing the properties of the bit-stream with a database containing properties of a number of coding schemes.

8. A method as claimed in claim 1, wherein said step of selectively reading predetermined parameters comprises: locating said predetermined parameters within the bit-stream by using the syntax description;
reading the located predetermined parameters; and
decoding the predetermined parameter using the decoder description.

9. A method as claimed in claim 1, wherein said predetermined parameters relate to a first set of frequency bands, and wherein the step of deriving the hash function comprises deriving estimates of values of spectral information present in a second set of frequency bands from the predetermined parameters, the hash function subsequently being calculated from the estimated values.

10. A method as claimed in claim 1, wherein said multimedia signal is compressed using a parametric encoding scheme, and wherein the predetermined parameters relate to at least one of the sinusoidal components, the noise components and the transient components utilised within the parametric scheme.

11. A computer program arranged to perform the method as claimed in claim 1.

12. A record carrier comprising a computer program as claimed in claim 11.

13. A method of making available for downloading a computer program as claimed in claim 11.

14. A hash signal representative of a multimedia signal, the hash signal having been generated by selectively reading predetermined parameters relating to perceptual properties of the multimedia signal from a bit-stream comprising a compressed version of the multimedia signal.

15. An apparatus arranged to generate a hash signal representative of a multimedia signal, the apparatus comprising:
a receiver arranged to receive a bit-stream comprising a compressed multimedia signal;
a decoder (210) arranged to selectively read from the bit-stream predetermined parameters;
a processing unit (270) arranged to derive a hash function from said parameters.
